(19) United States
(12) Patent Application Publication
(10) Pub. No.: US 2013/0201139 A1
(43) Pub. Date: Aug. 8, 2013

(54) USER INTERFACE APPARATUS AND MOBILE TERMINAL APPARATUS

(71) Applicant: KYOCERA CORPORATION, Kyoto (JP)

(72) Inventor: Nao TANAKA, Daito-shi (JP)

(73) Assignee: KYOCERA CORPORATION, Kyoto (JP)

(21) Appl. No.: 13/828,123

(22) Filed: Mar. 14, 2013

Related U.S. Application Data
(63) Continuation of application No. 12/726,184, filed on Mar. 17, 2010.

(30) Foreign Application Priority Data
Mar. 31, 2009 (JP) 2009-87966

(51) Int. Cl. G06F 3/041

(52) U.S. Cl. CPC G06F 3/0414
USPC 345/173

(57) ABSTRACT

A user interface apparatus includes two touch panels. A drag & drop operation over the two touch panels is described. Adjacent first and second touch panels display a display object, and a location of a designated point related to a display object is determined based on certain conditions. The display object is then displayed on one of the touch panels at the determined location.

### RELATED APPLICATIONS

The present application is a continuation application of an U.S. application Ser. No. 12/726,184, filed on Mar. 17, 2010, which claims priority under 35 U.S.C. §119 to Japanese Patent Application No. 2009-087966, filed, Mar. 31, 2009, entitled “USER INTERFACE APPARATUS AND MOBILE TERMINAL DEVICE,” the entirety of which is incorporated herein by reference.

### FIELD OF THE INVENTION

Embodiments of the present invention generally relate to mobile terminal apparatuses, and more particularly relate to a mobile terminal apparatus comprising a user interface (UI) apparatus.

### BACKGROUND

Mobile terminal apparatuses comprising two touch panels are known. Mobile terminal apparatuses commercially available in recent years are able to accomplish very complicated functions comparable to personal computers, thus requiring a complex display performance.

For example, two touch panels may be used for a complex display of one computer function or feature. When both touch panels are utilized for display, a drag operation over the two touch panels may be necessary.

In such case, a user may touch a display object displayed on a first touch panel, such as a window, with his right hand. Meanwhile, the user may touch a desirable position on a second touch panel with his left hand. He may thereafter remove his left hand from the second touch panel to transfer the display object on the first touch panel to the second touch panel.

However, since mobile terminal apparatuses are typically manipulated using one hand, using both hands may be inconvenient to and burden the user.

Therefore, there is a need for an easy one-hand operation on a plurality of touch panels such as movement of a display object between the plurality of touch panels.

### SUMMARY

A user interface apparatus includes two touch panels. A drag & drop operation over the two touch panels is described. Adjacent first and second touch panels display a display object, and a location of a designated point related to a display object is determined based on certain conditions. The display object is then displayed on one of the touch panels at the determined location.

In one embodiment, a user interface (user interface apparatus) includes a first touch panel operable to display one or more display objects, and a second touch panel operable to display the one or more display objects. The user interface also includes a determining unit, operably coupled to at least one of the first touch panel and the second touch panel, operable to determine a location of a designated point on the first touch panel when a first pressed point at a display object on the second touch panel is pressed, moved and released, and when movement of the first pressed point conforms to a predefined condition. The user interface also includes a display control unit, operably coupled to the determining unit, operable to display at least part of the display object on the first touch panel at the location determined by the determining unit, based on determination of the location of the designated point by the determining unit.

In another embodiment, a mobile terminal (mobile terminal apparatus) includes the user interface apparatus described herein.

In yet another embodiment, a user interface apparatus includes a first touch panel, and a second touch panel, where a display object displayed on the first touch panel or the second touch panel is operable to be dragged from one touch panel to another. The user interface apparatus also includes an executing unit, operably coupled to at least one of the first touch panel and the second touch panel, operable to execute an application program to provide a display on at least one of the first and second touch panels. The user interface apparatus also includes a controller operable to send a first message indicating a start of a press to the application program if the press starts on the display object on the first touch panel or the second touch panel, to determine a location of the press on the first touch panel or the second touch panel followed by sending a second message indicating the location of the press to the application program if the location of the press changes and the change of the location of the press conforms to a predefined condition, to send a third message indicating a release of the press to the application program if the press is released, and to inhibit sending the third message, determine a location of the press on the first touch panel followed by sending a second message indicating the location of the press to the application program, and inhibit sending the first message, if a press starts on a different touch panel from one on which the press has been released.

In still another embodiment, a user interface apparatus includes a display means for displaying a display object at a position corresponding to a press position on a touch panel of at least two touch panels. The user interface apparatus also includes a control means for controlling the display means to display at least part of the display object on a first touch panel of the at least two touch panels if a change in the press position on a second touch panel of the at least two touch panels between press start and press release conforms to a predefined condition.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the disclosure. The figures are provided to facilitate understanding of the disclosure without limiting the breadth, scope, scale, or applicability of the disclosure. The drawings are not necessarily made to scale.

FIG. 1A is a perspective view of a mobile terminal apparatus according to an embodiment of the present invention, illustrating an icon on a second touch panel touched by a finger before moving to a first touch panel.

FIG. 1B is a perspective view of the mobile terminal apparatus, illustrating the icon moving from the second touch panel to the first touch panel.

FIG. 1C illustrates a new e-mail screen that has popped up on the second touch panel after the icon has moved from the first touch panel to the second touch panel.

FIG. 2 is a block diagram showing exemplary components in a mobile terminal apparatus according to an embodiment of the present invention.

FIG. 3 is a front view schematically illustrating the mobile terminal apparatus illustrated in FIG. 1.

FIG. 4 is a schematic view of the two touch panels.

FIG. 5 is a flow chart illustrating an exemplary drag & drop operation by a user.

FIG. 6A illustrates a user starting to drag the icon on the second touch panel to a destination on the first touch panel.

FIG. 6B illustrates the icon further moving in a second boundary region toward the destination, following the operation illustrated in FIG. 6A.

FIG. 6C illustrates the icon further moving in a first boundary region toward the destination, following the operation illustrated in FIG. 6B.

FIG. 7 is a flow chart illustrating an exemplary drag & drop operation by a user.

FIG. 8A illustrates a user starting to drag the icon on the second touch panel to a destination on the first touch panel.

FIG. 8B illustrates the icon further moving in an upper edge region of the second touch panel toward the destination, following the operation illustrated in FIG. 8A.

FIG. 8C illustrates the icon further moving in a lower edge region of the first touch panel toward the destination, following the operation illustrated in FIG. 6B.

### DETAILED DESCRIPTION OF THE EMBODIMENTS

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the invention. Furthermore, there is no intention to be bound by any expressed or implied theory presented in the preceding technical field, background, brief summary or the following detailed description. The present disclosure should be accorded scope consistent with the claims, and not limited to the examples described and shown herein.

Embodiments of the disclosure are described herein in the context of practical non-limiting applications, namely, a user interface device. Embodiments of the disclosure, however, are not limited to such user interface devices, and the techniques described herein may also be utilized in other user interface applications. For example, embodiments may be applicable to electronic game machines, digital music players, personal digital assistants (PDA), personal handy phone system (PHS), lap top computers, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

The following description is presented to enable a person of ordinary skill in the art to make and use the embodiments of the disclosure. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the embodiments of the present disclosure. Thus, the embodiments of the present disclosure are not intended to be limited to the examples described herein and shown, but are to be accorded the scope consistent with the claims.

In an embodiment, a mobile telephone comprising two touch panels is described as a mobile terminal apparatus according to the present invention. A drag & drop operation over the two touch panels is described. However, it shall be understood by those of ordinary skill in the art that the embodiments of the present invention are not limited to embodiments having two touch panels. Alternatively, three, four or more touch panels may be used. Furthermore, embodiments of the present invention are not limited to a drag & drop operation, and may include such operations as ‘move’ and/or ‘cut and paste’, for example.

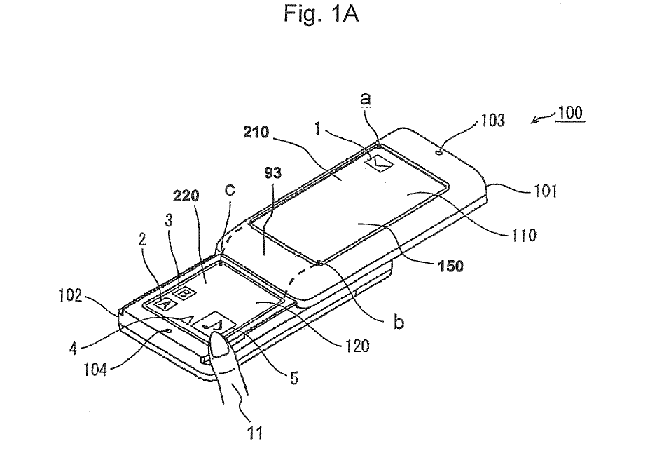

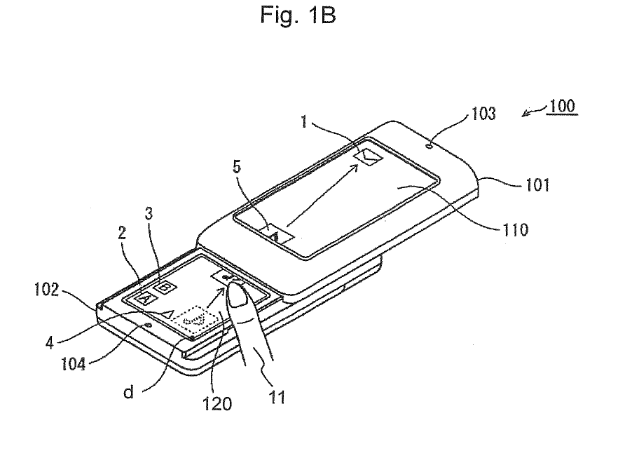

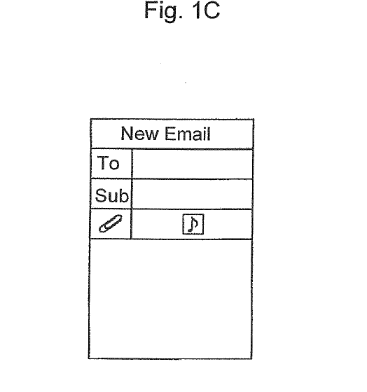

FIG. 1A is a perspective view of a mobile terminal apparatus (mobile terminal) according to an embodiment of the present invention, illustrating an icon on a second touch panel touched by a finger before being moved to a first touch panel. FIG. 1B is a perspective view of the mobile terminal apparatus, illustrating movement of the icon from the second touch panel to the first touch panel. FIG. 1C illustrates a new e-mail screen that popped up on the second touch panel after the icon has moved from the first touch panel to the second touch panel.

A mobile telephone 100 is a slide mobile telephone in this embodiment. The mobile telephone 100 includes a first housing 101 and a second housing 102. The first housing 101 and the second housing 102 are slidable. The housing 101 includes a speaker 103 and a first touch panel 110. The housing 102 includes a microphone 104 and a second touch panel 120. The first touch panel 110 includes an end point a and an end point b. The second touch panel 120 includes an end point c and an end point d.

The touch panels 110 and 120 are able to display such items as keys, including a cursor key and a numeric keypad, and an icon. A user may perform different operations by touching the touch panels using, for example, a pen, a bar or a finger. In the present embodiment, an e-mail icon 1 is displayed on the first touch panel 110. Text file icons 2 and 3, an e-mail application icon 4, and a music file icon 5 are displayed on the second touch panel 120. A user touches the icon 5 with a finger 11 to start a drag operation (FIG. 1A). By such an operation, an icon of any data file such as photo data, video data, text data, and diagram data may be dragged.

The user drags the icon 5 toward the first touch panel 110. More specifically, the user's finger 11 touches the icon 5 located on a lower right corner of the second touch panel 120 (applying a pressure (a pressing force) on the second touch panel 120) (FIG. 1A), and slides the finger 11, keeping contact with the icon 5 on the second touch panel 120 so that it moves toward the first touch panel 110. Then, the finger 11 reaches an upper end of the second touch panel 120 (FIG. 1B).

Similarly, in the drag operation over the two touch panels, the user slides the finger 11 on a surface of the housing until the finger enters the first touch panel 110. The dragging of the icon 5 is not released on a boundary of the second touch panel 120 at the side of the first touch panel 110. Rather, the dragging is continued on the first touch panel 110.

Then, the user further slides his finger on the first touch panel 110 and drops the icon 5 on the mail icon 1. More specifically, the finger sliding on the first touch panel 110 arrives at a position of the icon 1 on the first touch panel 110, and the finger is then removed from the first touch panel 110 (the pressure on the first touch panel 110 is released). As a result, a new mail creation screen with a file corresponding to the dropped icon 5 is displayed as illustrated in FIG. 1C. Though the finger is located at an upper end of the second touch panel 120 in FIG. 1B, the finger similarly travels to the icon 1 on the first touch panel while continuously touching the first touch panel along an arrow.

More specifically, the mobile telephone 100 includes a virtual touch panel 150 which includes the first touch panel 110, the second touch panel 120, and a bezel 93. The icon 5 can be moved on the virtual touch panel 150. That is, the user is able to perform the drag & drop operation over the two touch panels as if the drag & drop operation was performed on one display.

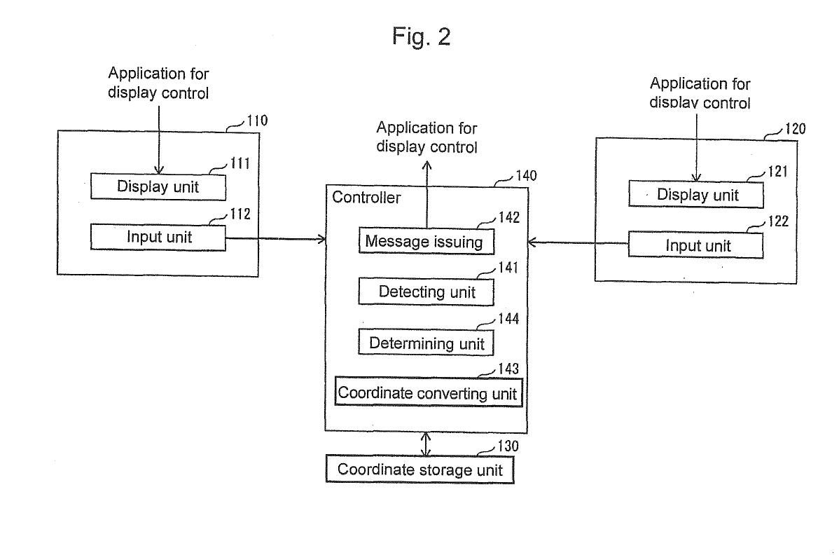

FIG. 2 is a block diagram showing exemplary components in a mobile terminal apparatus 100 according to an embodiment of the present invention. FIG. 2 illustrates relationships among the components for explaining the operation.

The mobile telephone 100 may further include a processor and a memory. In an embodiment illustrated in FIG. 2, the mobile telephone 100 includes a coordinate storage unit 130 and a controller 140 as well as the first touch panel 110 and the second touch panel 120. The controller 140 may include the processor which executes a control program stored in the memory.

The first touch panel 110 includes a first display unit 111 and a first input unit 112, and the second touch panel 120 includes a second display unit 121 and a second input unit 122.

The display units each may include an LCD (Liquid Crystal Display). The display units may be defined as a circuit for displaying characters and images such as icons on the LCD in response to instructions from an application for display control

The application for display control is stored in the memory. The application is a program to be executed by the processor for display-controlling the LCD in response to messages from an OS (Operating System).

In the description given below, the number of (longitudinal and transverse) pixels of the LCD in the first display unit 111 is, for example and without limitation, 150×300 pixels, and number of (longitudinal and transverse) pixels of the LCD in the second display unit 121 is, for example and without limitation, 150×200 pixels.

The first display unit 111 includes a first coordinate system 210, and the second display unit 121 includes a second coordinate system 220. Reference symbols x and y of the coordinate systems 210 and 220 respectively have values corresponding to the numbers of pixels. For example, x has values of 0-150 and y has values of 0-300 in the first coordinate system 210, and x has values of 0-150 and y has values of 0-200 in the second coordinate system 220.

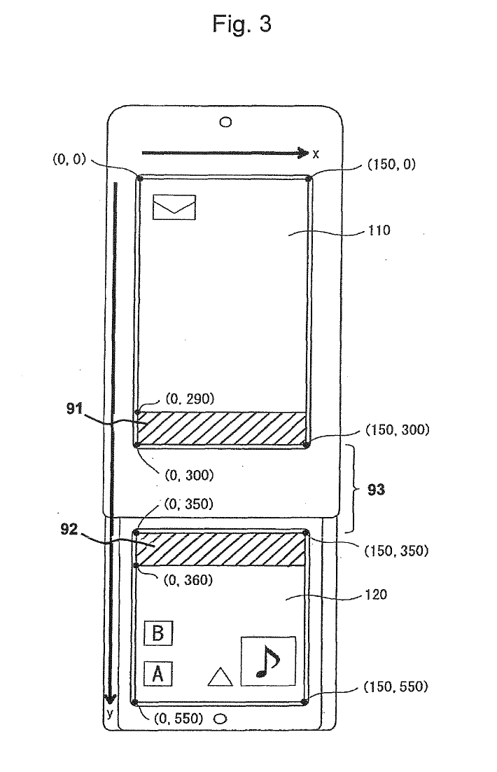

Specifically, in the first coordinate system 210, for example and without limitation, the point a illustrated in FIG. 1A (upper-left end of the LCD in the first touch panel 110) is represented by first coordinate values (0, 0), and the point b (lower-right end of the LCD in the first touch panel 110) is represented by first coordinate values (150, 300) as illustrated in FIG. 3. Similarly, in the second coordinate system 220, for example and without limitation, the point c illustrated in FIG. 1A (upper-left end of the LCD in the second touch panel 120) is represented by second coordinate values (0, 0), and the point d illustrated in FIG. 1B (lower-right end of the LCD in the second touch panel 120) is represented by second coordinate values (150, 200) as illustrated in FIG. 3.

The first input unit 112 and the second input unit 122 detect touches made by a user, and simultaneously transmit coordinate values (x, y) of positions touched by the user to the controller 140 at the intervals of unit time (for example, every 1/60 second). Although ‘unit time’ is referred to in the description, it is not so limited, and may include any lengths of time. The first and second input units 112 and 122 may be, for example and without limitation, of resistive type, optical (infrared) type, or capacitance type, such as that used in a common touch panel.

According to an embodiment, the first input unit 112 outputs the first coordinate values (0, 0) when the point a (FIG. 1A) is touched and outputs the first coordinate values (150, 300) when the point b (FIG. 1A) is touched, respectively to the controller 140. The second input unit 122 outputs the second coordinate values (0, 0) when the point c (FIG. 1A) is touched and outputs the second coordinate values (150, 200) when the point d (FIG. 1B) is touched, respectively to the controller 140.

As mentioned above, the mobile telephone 100 includes the coordinate storage unit 130. The coordinate storage unit 130, in turn, includes a memory region for storing the different coordinate values.

The controller 140 functions as an OS to be an intermediate between the touch panels and the application for display control. The controller 140 controls dimensions, shapes, and locations (coordinates) of such items as icons on the touch panels, for example, as with any other operating systems. The controller 140 further transmits messages corresponding to the user's operations on the touch panels to the application that is display-controlling a manipulated part.

Referring again to the controller 140, in one embodiment the controller 140 includes a detecting unit 141, a message issuing unit 142, a coordinate converting unit 143, and a determining unit 144. The detecting unit 141 may detect operating states of the respective touch panels handled by a user based on the coordinate values received from the input units. The operating states of the first and second touch panels 110 and 120 include a touch state, a detach state, and a drag state. The touch state denotes a state where the touch panel is touched by a user's finger or other tool. In other words, it is a state where a pressure is applied on the touch panel. The detach state denotes a state where the finger is removed from the touch panel. In other words, it is a state where the pressure applied on the touch panel is released. The drag state denotes a state where the generated touch state is not followed by the detach state. The term drag state may be used to indicate movements of the touched position. However, the drag state here includes a touched position that remains unmoved.

Referring now to the messaging issuing unit 142, the message issuing unit 142 transmits messages based on a detection result obtained by the detecting unit 141 or a determination result obtained by the determining unit 144 to the application for display control. These messages will be described below in greater detail.

Referring now to the coordinate converting unit 143, the coordinate converting unit 143 converts the first and second coordinate values received from the first input unit 112 and/or second input unit 122 (physical coordinate values) into third coordinate values (logical coordinate values) in a third coordinate system (coordinate system for operation control), and stores the converted third coordinate values in the coordinate storage unit 130.

The third coordinate system is described below.

FIG. 3 is a schematic illustration of the mobile terminal apparatus illustrated in FIG. 1 in front view.

The third coordinate system, which corresponds to the virtual touch panel 150, is defined, for example and without limitation, as follows. In the example, the third coordinate system, with coordinate values of the upper-left corner on the first touch panel 110 (point a in FIG. 1A) as an origin (0, 0), has an x axis extending right from the origin and a y axis extending downward therefrom.

In the first touch panel 110, coordinate values of the upper-right end are (150, 0), coordinate values of the lower-left end are (0, 300), and coordinate values of the lower-right end (point b in FIG. 1A) are (150, 300). In the second touch panel 120, coordinate values of the upper-left end (point c in FIG. 1A) are (0, 350), coordinate values of the upper-right end are (150, 350), coordinate values of the lower-left end are (0, 550), and coordinate values of the lower-right end (point d in FIG. 1B) are (150, 550).

The y coordinate of the upper end on the second touch panel 120 may be determined based on a width of the bezel 93. More specifically, the y coordinate is assigned including the width of the bezel 93 in the third coordinate system. In the present embodiment, the y coordinate of the bezel 93 ranges from 300 to 350.

The first touch panel 110 includes a first boundary region 91. The y coordinate of the first boundary region 91 ranges from 350 to 360. The second touch panel 120 includes a second boundary region 92. The y coordinate of the second boundary region 92 ranges from 290 to 300.

Also in the example, the first input unit 112 transmits the coordinate values (0, 0) when the upper-left end (point a) of the LCD in the first touch panel 110 is touched, and transmits the coordinate values (150, 300) when the lower-right end (point b) thereof is touched, respectively to the controller 140 as the first coordinate values.

The second input unit 122 transmits the coordinate values (0, 0) when the upper-left end (point c) of the LCD in the second touch panel 120 is touched, and transmits the coordinate values (150, 200) when the lower-right end (point d) thereof is touched, respectively to the controller 140 as the third coordinate values.

Thus, in the example, the physical coordinate values received from the first touch panel 110 (first input unit 112) are equal to the logical coordinate values of the third coordinate system. Therefore, the coordinate converting unit 143 directly uses the first coordinate values received from the first touch panel 110 (first input unit 112) as the third coordinate values. On the contrary, the coordinate converting unit 143 adds “350” to the y coordinate of the second coordinate values received from the second touch panel 120 (second input unit 122) and uses resulting values as the third coordinate values.

When a dragged position detected by the detecting unit 141 is moved out of the first touch panel 110, in other words, when the detach state occurs in the first touch panel 110, the determining unit 144 (see FIG. 2) determines whether or not the drag state should be continued in the second touch panel 120 based on the third coordinate values stored in the coordinate storage unit 130.

More specifically, in one aspect, drag is continued where the position at which the drag state shifts to the detach state in the first touch panel 110 (e.g., a position most recently touched or a pre-movement coordinate system) is located in the first boundary region of the first touch panel 110, and further where an absolute value of drag speed at the position is at least a predetermined value.

According to an embodiment, the drag speed is defined by subtracting the y coordinate value of a position touched earlier by unit time ( 1/60 second in this example) than the position most recently touched from the y coordinate value of the position most recently touched. A description is given below referring to the predetermined value hypothetically and by way of example, set to “2”, except for the drag speed showing a negative value when the drag state is shifted to the detach state in the first touch panel 110. Alternatively, when the drag speed shows a positive value, when the drag state is shifted to the detach state in the second touch panel 120, the drag speed is regarded as “0”.

Furthermore, in the case where the determining unit 144 determines that the drag state should be continued and the user continues the drag without detaching his finger on the virtual touch panel 150, the coordinate values of a position very likely touched by the user (“destination coordinate values”) may be decided based on the logical coordinate values stored in the coordinate storage unit 130, at intervals of unit time, for example.

Below is described a method for deciding the destination coordinate values.

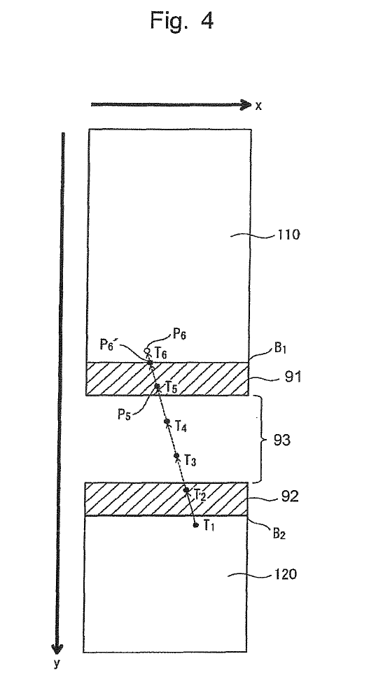

FIG. 4 is a schematic view of the two touch panels 110 and 120, where the movement of the user's finger on the touch panels is illustrated.

Assuming that the coordinate values of the position most recently touched by the user (time point T2) on the second touch panel 120 are (x2, y2), and the coordinate values of the position touched earlier by the unit time (time point T1) are (x1, y1), an amount of the movement per unit time can be calculated as (x2−x1, y2−y1).

Provided that the movement amount per unit time is constant, therefore, the coordinate values of a position very likely touched at a time point T3 later than the time point T2 by the unit time (destination coordinate values) are (2×x2−x1, 2×y2−y1), and the destination coordinate values of the position very likely touched at a time point T4 further later by the unit time can be decided as (3×x2−2×x1, 3×y2−2×y1).

As the destination coordinate values are thus decided, the coordinate values of a position P6 at a time point T6 are beyond the boundary region (first boundary region in this example) of the other touch panel. This other touch panel is different from the touch panel most recently (time point T2) touched (first touch panel 110 in this example). In such a case, the determining unit 144 uses the coordinate values of a position P6′ on a boundary (boundary B1 in this example) of the other touch panel as the destination coordinate values.

The coordinate values of the position P6′ are the coordinate values of a point where the boundary B1 and a straight line connecting a position (P5) very likely touched at a time point T5 to the position P6 very likely touched at the time point T6 intersect with each other. The straight line connecting the position P5 and the position P6 to each other is represented by a primary function (y=ax+b), and values of constants a and b can be calculated when simultaneous equations are solved. When the y coordinate (290 in this example) of the boundary B1 is simply assigned to the equation (y=ax+b) so that the x coordinate is calculated, the coordinate values of the position P6′ can be easily calculated. Therefore, a more detailed description is not presented here.

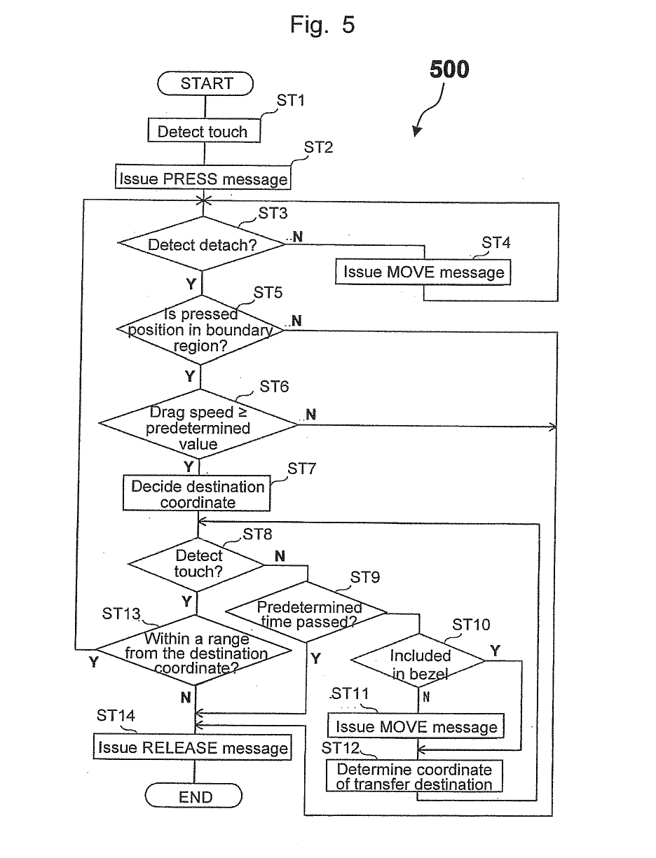

FIG. 5 is a flow chart 500 illustrating an example of control processing steps for the drag & drop operation by the user. The detecting unit 141 detects the touch state upon the reception of the first or second coordinate values from the first or second touch panel (task ST1).

The message issuing unit 142 issues a PRESS message to the application for display control based on a detection result obtained by the detecting unit 141 (task ST2). The PRESS message is a message indicative of the touch state, including the first or second coordinate values (coordinate values received in task ST1) of the touched position and discriminatory information of the touch panel that transmitted the coordinate values. The application for display control, for example, controls the display so as to display a state where an icon at the first or second coordinate values included in the PRESS message is selected.

The coordinate converting unit 143 converts the first or second coordinate values received in the task ST1 into the third coordinate values of the third coordinate system and stores the converted coordinate values in the coordinate storage unit 130.

The detecting unit 141 determines at the intervals of unit time ( 1/60 second in this example) whether or not occurrence of the detach state is detected in the touch panel detected as having the touch state in the task ST1 (task ST3). More specifically, it is practically determined whether or not the coordinate values were received because the coordinate values are received from the target touch panel at the intervals of unit time as long as the touch state lasts. Then, it is determined that the detach state was detected in the case where the coordinate values were not received.

When the detecting unit 141 did not detect the detach state (task ST3; N), the message issuing unit 142 issues a MOVE message for the application for display control based on the detection result of the detecting unit 141 (task ST4). Accordingly, the coordinate converting unit 143 converts the first or second coordinate values received in the task ST3 into the third coordinate values of the third coordinate system and stores the converted values in the coordinate storage unit 130, and the detecting unit 141 again determines the task ST3.

The MOVE message is a message indicative of a movement position, including the coordinate values of the touched position (coordinate values received in the task ST3) and discriminatory information of the touch panel that transmitted the coordinate values. The application for display control, for example, controls the display so as to move the icon to the coordinate values included in the MOVE message.

When the detecting unit 141 detects the detach state (task ST3; Y), the determining unit 144 determines whether or not the logical coordinate values of the position most recently touched stored in the coordinate storage unit 130 are included in the boundary region of the touch panel detected as having the touch state in the task ST1 (first boundary region or second boundary region) (task ST5). In the case where the values are not included in the boundary region (task ST5; N), the message issuing unit 142 issues a RELEASE message for the application for display control based on the negative determination result obtained by the determining unit 144 (task ST14), and the control processing is then ended.

The RELEASE message is a message indicative of the detach state, specifying the coordinate values of the position most recently touched (obtained by reconverting the corresponding logical coordinate values stored in the coordinate storage unit 130 into the physical coordinate values) and discriminatory information of the touch panel that transmitted the coordinate values. The message issuing unit 142 includes the discriminatory information of the first touch panel 110 in the RELEASE message in the case where the y coordinate value of the corresponding logical coordinate is below 350, while including the discriminatory information of the second touch panel 120 in the RELEASE message in the case where the y coordinate value of the corresponding logical coordinate is above 350. The application for display control controls the display so as to stop any movement of the icon farther than the coordinate values included in the RELEASE message.

In a case where the logical coordinate values of the position most recently touched stored in the coordinate storage unit 130 are included in the boundary region of the touch panel detected as having the touch state in the task ST1 (task ST5; Y), the determining unit 144 calculates the drag speed from the y coordinate value associated with the determination result (logical y coordinate value) and the logical y coordinate value of the position touched earlier by unit time stored in the coordinate storage unit 130, and determines whether or not the absolute value of the drag speed is at least a predetermined value (task ST6).

In a case where the absolute value of the drag speed is less than the predetermined value (task ST6; N), the message issuing unit 142 similarly issues the RELEASE message for the application for display control (task ST14), and the control processing is then ended.

In a case where the absolute value of the drag speed is at least the predetermined value (task ST6; Y), the determining unit 144 calculates the movement amount per unit time from the two logical coordinate values of the position most recently touched and the position touched earlier by the unit time which are stored in the coordinate storage unit 130, and decides the destination coordinate values later by the unit time (task ST7).

The detecting unit 141 determines, at the intervals of unit time ( 1/60 second in this example), whether or not occurrence of the touch state is detected in the other touch panel, which other touch panel is different to the touch panel detected as having the detach state in the task ST3 (task ST8). That is, it is determined whether or not the coordinate values were received from the other touch panel. With no reception of the coordinate values (task ST8; N), the detecting unit 141 determines whether or not a predetermined time already passed (for example, 1 second) after the detach state was detected in the task ST3 (task ST9). In a case where the predetermined time already passed (task ST9; Y), the message issuing unit 142 similarly issues the RELEASE message to the application for display control (task ST14), and the control processing is then ended. In a case where the predetermined time is yet to pass (task ST9; N), the determining unit 144 determines whether or not the destination coordinate values stay in the range of the bezel 93 (that is to determine if the logical y coordinate value ranges from 300 to 350) (task ST10).

Furthermore, in a case where the destination coordinate values are beyond the range of the bezel 93 (task ST10; N), the message issuing unit 142 issues the MOVE message (task ST11). The MOVE message issued then is indicative of the movement position as with the MOVE message described in the task ST4. However, the MOVE message here is different than the MOVE message described previously, in that the coordinate values included in the message are obtained by reconverting the destination coordinate values most recently decided (one of the destination coordinate values decided in the task ST7 and a task ST12 described later) into the physical coordinate values. A method for deciding the discriminatory information of the touch panel to be included in the MOVE message is similar to the method for deciding the RELEASE message described earlier.

The determining unit 144 decides the destination coordinate values obtained later by unit time based on the destination coordinate values most recently decided and the movement amount per unit time calculated in the task ST7 (task ST12), and restarts the processing steps in and after the task ST8. In a case where the destination coordinate values stay in the range of the bezel 93 (task ST10; Y), the determining unit 144 skips the task ST11 and proceeds to the task ST12.

In a case where the detecting unit 141 detects occurrence of the touch state in the task ST8, in other words, the coordinate values are received from the other touch panel (task ST8; Y), the coordinate converting unit 143 converts the received coordinate values into the third coordinate values of the third coordinate system and stores the converted values in the coordinate storage unit 130. Further, the determining unit 144 determines whether or not the obtained third coordinate values are included in a definite range including the destination coordinate values most recently decided as its median (for example, range represented by a circle having a radius equal to 50 coordinates) (task ST13).

In the case where the third coordinate values are included in the definite range near the destination coordinate values most recently decided (task ST13; Y), the determining unit 144 restarts the processing steps in and after the task ST3 without issuing the RELEASE message. The determining unit 144 issues the RELEASE message for the application for display control (task ST14) in the case where the third coordinate values are not included in the definite range (task ST13; N). The control processing is then ended.

The control processing steps of the mobile telephone 100 are described below referring to a specific example.

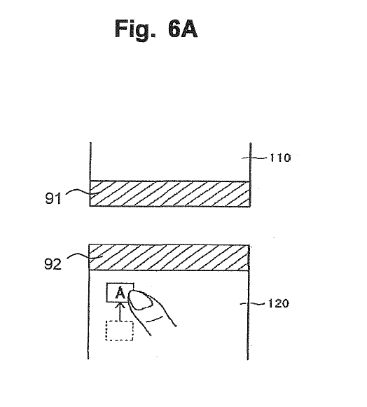

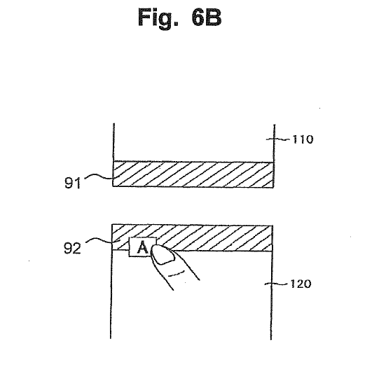

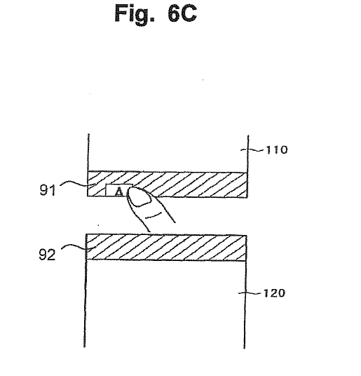

A description is given below referring to FIGS. 6A to 6C in the case where a user drags an icon 2 displayed on the second touch panel 120 illustrated in FIG. 1A toward the first touch panel 110.

FIGS. 6A to 6C illustrate a transition of the control processing by the mobile telephone 100. FIG. 6A illustrates a state immediately after the user started to drag the icon on the second touch panel 120. FIG. 6B illustrates a state after the user moved the icon to the second boundary region 92 subsequent to the state illustrated in FIG. 6A. FIG. 6C illustrates a state after the user moved the icon to the first boundary region 91 subsequent to the state illustrated in FIG. 6B.

When the user touches the icon 2 with his finger, the detecting unit 141 receives the coordinate values (for example, (50, 150)) from the second touch panel 120 and thereby detects the touch state (task ST1 of FIG. 5). The message issuing unit 142 then issues the PRESS message including the received coordinate values (50, 150) and the discriminatory information of the second touch panel 120 for the application for display control (task ST2). The coordinate converting unit 143 converts the coordinate values (50, 150) received in the task ST1 into the third coordinate values (50, 500) of the third coordinate system and stores the converted values in the coordinate storage unit 130.

Next, the detecting unit 141 determines at the intervals of unit time ( 1/60 second in this example) whether or not occurrence of the detach state is detected in the second touch panel 120. That is, the detecting unit 141 determines whether or not the coordinate values were received from the second touch panel 120 (task ST3). The detach state is not detected while the user continues to drag the icon 2 on the second touch panel 120 as illustrated in FIG. 6A (task ST3; N). Therefore, the message issuing unit 142 issues the MOVE message including the received coordinate values (for example, (48, 145)) and the discriminatory information of the second touch panel 120 for the application for display control (task ST4). The application for display control controls the display so as to move the icon to the coordinate values on the second touch panel 120 included in the MOVE message (FIG. 6A).

The coordinate converting unit 143 converts the received coordinate values (48, 145) into the third coordinate values of the third coordinate system (48, 495) and stores the converted values in the coordinate storage unit 30. The detecting unit 141 again determines the task ST3.

The tasks ST3-ST4 are repeatedly carried out as described earlier during the drag of the icon 2 by the user. When the user removes his finger at a position illustrated in FIG. 6B, the detecting unit 141 fails to receive the coordinate values from the second touch panel 120 and detects the detach state (task ST3; Y).

The logical coordinate values of the position most recently touched stored in the coordinate storage unit 130 (for example, (46, 355)) are included in the second boundary region 92 of the second touch panel 120 (task ST5; Y). The absolute value of the value obtained by subtracting, from the logical y coordinate value (355) associated with the determination, the logical y coordinate value of the position touched earlier by unit time (for example, “358”) which is stored in the coordinate storage unit 130 (meaning that the drag speed is “−3”) is at least the predetermined value (“2” in the present embodiment) (task ST6; Y). Accordingly, the determining unit 144 decides the destination coordinate values obtained later by unit time. More specifically, the determining unit 144 calculates the movement amount per unit time (0, −3) from the logical coordinate values (46, 355) of the position most recently touched and the logical coordinate values of the position touched earlier by the unit time (for example, (46, 358)) which are stored in the coordinate storage unit 130, and accordingly decides the destination coordinate values obtained later by the unit time (46, 352) (task ST7).

In another case the user has not yet touched the first touch panel 110, the detecting unit 141 fails to receive the coordinate values from the first touch panel 110 and does not detect the touch state (task ST8; N). The predetermined time (1 second in this example) is yet to pass (task ST9; N) at this time with only 1/60 second after the detach state was detected in the task ST3. Then, the determining unit 144 determines whether or not the destination coordinate values are included in the range of the bezel 93 (that is, the determining unit 144 determines if the logical y coordinate value ranges from 300 to 350) (task ST10).

In the given example, the destination coordinate values (46, 352) are not included in the range of the bezel 93 (task ST10; N). Therefore, the message issuing unit 142 issues the MOVE message including the physical coordinate values (46, 2) obtained by reconverting the destination coordinate values and the discriminatory information of the second touch panel 120 (task ST11). The application for display control controls the display so as to move the icon to the coordinate values (46, 2) on the second touch panel 120 included in the MOVE message.

The determining unit 144 decides the destination coordinate values obtained later by the unit time (46, 349) based on the destination coordinate values (46, 352) and the movement amount per unit time (0, −3) calculated in the task ST7 (task ST12).

In the case where the first touch panel 110 is still untouched in the task ST8, the detecting unit 141 does not detect the touch state (task ST8; N), and the predetermined time (1 second in this example) has not passed since the detach state was detected in the task ST3 (S9; N). Therefore, the determining unit 144 determines whether or not the destination coordinate values are included in the range of the bezel 93 (that is to determine if the logical y coordinate value ranges from 300 to 350) (task ST10).

Since the destination coordinate values decided in the task ST12 (46, 349) are included in the range of the bezel 93 (task ST10; Y). Therefore, the message issuing unit 142 does not issue the MOVE message, and the determining unit 144 decides the destination coordinate values obtained later by the unit time (46, 346) based on the destination coordinate values (46, 349) and the movement amount (0, −3) per unit time calculated in the task ST7 (task ST12).

The processing steps of the tasks ST8-ST12 are repeatedly carried out, during which the application for display control controls the display so as to move the icon to the coordinate values included in the MOVE message issued by the message issuing unit 142. Then, the icon 2 is finally displayed on the first touch panel 110.

When the user touches the first touch panel 110 as illustrated in FIG. 6C, the detecting unit 141 receives the coordinate values (for example, 55, 297)) from the first touch panel 110. Then, the detecting unit 141 detects the touch state (task ST8; Y), and the coordinate converting unit 143 converts the received coordinate values into the third coordinate values (55, 297) in the third coordinate system and stores the converted values in the coordinate storage unit 130.

The logical coordinate values are included in a definite range including the destination coordinate values most recently decided (for example, 46, 295) as its median (for example, range represented by a circle having a radius equal to 50 coordinates) (task ST13; Y). Therefore, the issuance of the RELEASE message is skipped, in other words, the drag state is retained, and the processing steps in and after the task ST3 are restarted.

The user thereafter continues to drag the icon 2 on the first touch panel 110, and the detecting unit 141 does not detect the detach state during the drag (task ST3; N). Then, the message issuing unit 142 issues the MOVE message (task ST4), and the application for display control controls the display as to move the icon to the coordinate values on the first touch panel 110 included in the MOVE message.

When the user drags the icon 2 to a desirable position and removes his finger from the first touch panel 110, the detecting unit 141 no longer receives the coordinate values from the first touch panel 110, thereby detecting the detach state (task ST3; Y). Because the logical coordinate values of the position most recently touched are not included in the second boundary region 92 of the second touch panel 120 detected as having the touch state in the task ST1 (task ST5; N), the message issuing unit 142 issues the RELEASE message for the application for display control (task ST14), and the control processing is ended.

As described so far, the user can perform the drag & drop operation between a plurality of distant touch panels as if he was performing the operation on one display.

Next, a modified embodiment is described, where a condition to be set is not whether or not the icon is included in the boundary region but whether or not a part of the icon is included in the range of the bezel 93. The description of the present modified embodiment focuses on differences as compared to the embodiment described earlier.

In a mobile telephone according to the present embodiment, a part of the processing steps in FIG. 5 is different. In place of the task ST5, it is determined if a part of the icon is included in the range of the bezel 93 (task ST25).

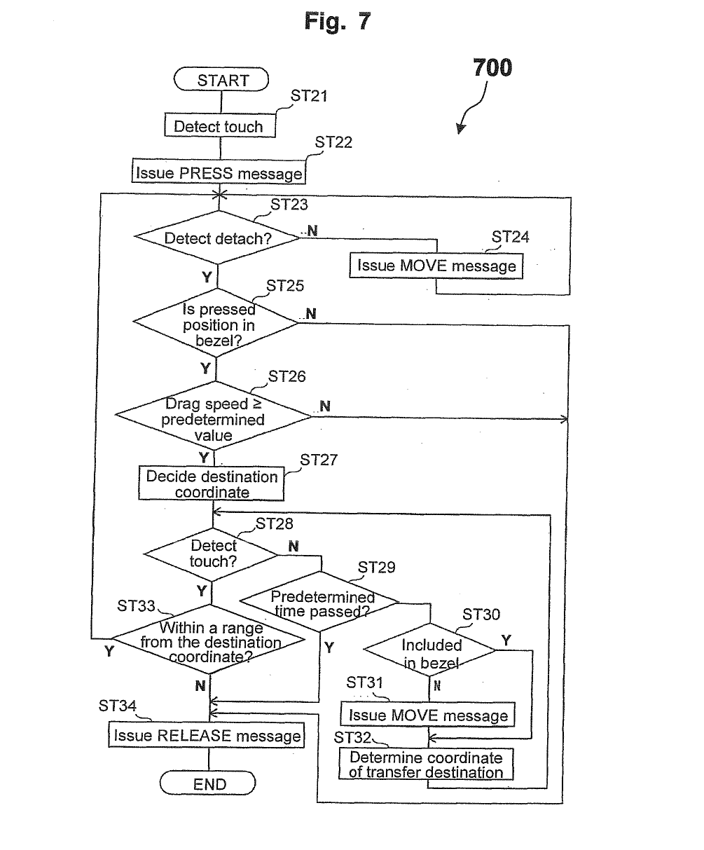

FIG. 7 is a flow chart 700 illustrating an example of control processing steps for the drag & drop operation by the user.

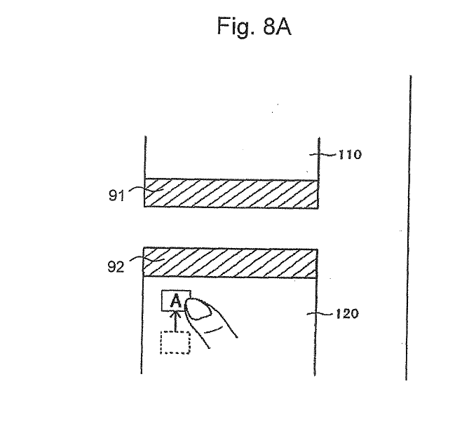

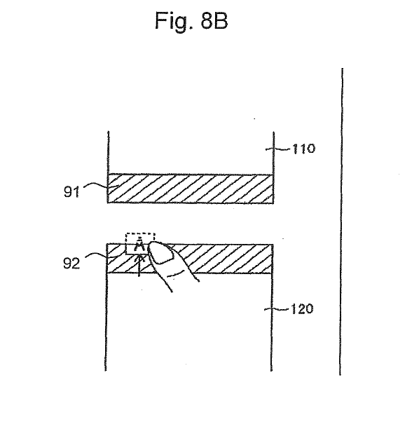

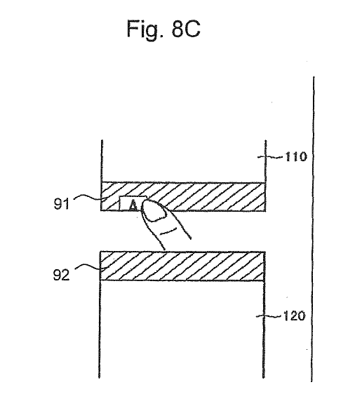

FIGS. 8A to 8C are illustrations of a transition of the control processing by the mobile telephone 100. FIG. 8A illustrates a state immediately after the user started to drag the icon on the second touch panel 120. FIG. 8B illustrates a state after the user moved the icon to the upper end of the second touch panel 120 subsequent to the state illustrated in FIG. 8A. FIG. 8C illustrates a state after the user moved the icon to the lower end of the first touch panel 110 subsequent to the state illustrated in FIG. 8B.

When the user touches the icon 2 with his finger and drags the icon 2 toward the first touch panel 110 (see FIG. 8A), the processing steps of the tasks ST21 to ST24 illustrated in FIG. 7 are carried out in the manner described earlier as ST1 to ST4. When the user then removes his finger at a position illustrated in FIG. 8B, the detecting unit 141 detects the detach state (task ST23; Y). The determining unit 144 determines whether or not a part of the icon dragged by the user is included in the range of the bezel 93 (if the logical y coordinate value stays in the range of 300-350) (task ST25).

The controller 140 controls the dimensions, shape, and location (coordinates) of the icon. Therefore, information indicative of a section of the icon first contacted is retained in the processing step of the task ST25. Then, the determining unit 144 determines whether or not a part of the icon is included in the range of the bezel 93 (if the logical y coordinate value stays in the range of 300-350) by, for example, specifying peak points of the icon from the position most recently touched on the touch panel based on the retained information.

In the example illustrated in FIG. 8B, a part of the icon is included in the range of the bezel 93 (logical y coordinate is included in the range of 300-350) (task ST25; Y), and the processing proceeds to the task ST26.

In the task ST26, the processing proceeds to the task ST27 after the implementation of the processing steps of the embodiment described earlier. In the task ST27, the processing step of the task ST27 described in the previous embodiment as ST7 is carried out. When the user touches the first touch panel 110 as illustrated in FIG. 8C, the detecting unit 141 detects the touch state (task ST28; Y) and implements the same processing steps as described in the embodiment. The tasks ST29 to ST34 are carried out as same as ST9 to ST14 in FIG. 5.

The mobile terminal apparatus according to the present invention was described based on the embodiment and its modified embodiment. However, the present invention is not limited to the mobile telephone configured as described in the embodiment and its modified embodiment. Other examples are described below.

A mobile telephone according an embodiment of the present invention, as far as it is equipped with two touch panels, may have other external appearances, for example, it may be of a folding (fold) type or bar (straight) type.

According an embodiment of the present invention, the first touch panel 110 and the second touch panel 120 may be respectively located on left and right sides in normal use when viewed from the user's side (the first touch panel 110 on left and the second touch panel 120 on right), in which case the x coordinates to be allocated in the third coordinate system preferably include the width of the bezel 93.

In a mobile telephone according an embodiment of the present invention, the first touch panel 110 and the second touch panel 120 are not necessarily located on substantially the same plane when they are slid as illustrated in FIG. 1A. These panels may be arbitrarily placed in any manner as far as they can be manipulated by a user so as to meet the conditions for continuing the drag from one of the touch panels to the other. For example, the first touch panel 110 may be disposed on a front surface of the mobile telephone with the second touch panel 120 disposed on a rear surface thereof.

It is not particularly necessary for a mobile telephone according an embodiment of the present invention to include the bezel 93 between the first touch panel 110 and the second touch panel 120. In that case, the y coordinates to be allocated in the third coordinate system preferably do not include the width of the bezel 93. The bezel 93 may be similarly omitted in the structure where the first touch panel 110 and the second touch panel 120 are disposed on left and right.

In an embodiment of the present invention, the movement per unit time or drag speed may be set to be constant when the destination coordinate values are decided. Alternatively, the movement amount per unit time may be, for example, decreased in the case where the destination coordinate values decided per unit time indicate any position on the other touch panel.

In an embodiment of the present invention, the destination coordinate values may be decided based on two coordinate values, namely the coordinate values of the position most recently touched and the coordinate values of the position touched earlier by unit time. The destination coordinate values may be decided based on three coordinate values or more. In that case, for example, it is preferable to obtain a Bézier curve from at least three coordinate values and decide the destination coordinate values based on the obtained Bézier curve.

In an embodiment of the present invention, the shapes of the first boundary region 91 and the second boundary region 92 may be rectangular, however, other shapes may be employed.

In an embodiment of the present invention, the predetermined value i may be “2” when determining if the absolute value of the drag speed is at least the predetermined value. However, the given value is merely an example, and other values (for example, “1”) may be used.

In an embodiment of the present invention, the message issued by the controller 140 for the application for display control may include the physical coordinate values. The discriminatory information of the touch panel that transmitted the physical coordinate values may, however, include the logical coordinate values instead.

It may be selectively decided which of the different messages is to be issued based on an instruction from the application for display control.

Any integrated circuit equipped with one or more chips, a computer program, and other technical means may be included as part of the components described above.

In an embodiment of the present invention, the touch panels and the display unit respectively correspond to the first and second touch panels 110 and 120, the application for display control stored in the memory, and the processor. However, these components are not so limited. An independent device or a component belonging to a device other than a mobile telephone may be used as far as the first and second touch panels are provided as input and output units. As such, a position on the first touch panel may be decided where variation of a position of a display object on the second touch panel subject to a pressure detected by the time when the pressure is released from the position since the pressure is first applied to the position meets a predetermined condition, and at least a part of the display object is displayed at the decided position.

The predetermined time in the task ST9 of FIG. 5 is 1 second in an embodiment of the present invention, however, is not necessarily limited thereto. The predetermined time may be 2 seconds or 3 seconds. Alternatively, an amount of time necessary for the user to drag the icon on the bezel 93 between the two touch panels by sliding his finger along the housing surface is measured in advance, and the measured time may be set as the predetermined time.

A user interface (UI) device (user interface) according to an embodiment of the present invention may include a first touch panel 110 and a second touch panel 120, wherein a display object, such as an icon, is displayed correspondingly at a position currently subject to a pressure by the time when the pressed position changes, thereby releasing the pressure, since the pressure is first applied to a position of the display object on the touch panels (that is the drag state).

A UI device according to an embodiment of the present invention may include a determining unit 144 and an application for display control; the determining unit 144 deciding a position on the first touch panel 110 in the case where variation of a position of a display object on the second touch panel 120 subject to a pressure detected by the time when the pressure is released from the position since the pressure is first applied to the position meets a predetermined condition, and the application for display control displaying at least a part of the display object at the position on the first touch panel 110 decided by the determining unit 144.

A UI device may include first and second touch panels, where a display object is displayed correspondingly at a position currently subject to a pressure by the time when the pressed position changes, thereby releasing the pressure, since the pressure is first applied to a position of the display object on the touch panels.

The UI device may include a determining means and a display means; the determining means for deciding a position on the first touch panel in the case where variation of a position of a display object on the second touch panel subject to a pressure detected by the time when the pressure is released from the position since the pressure is first applied to the position meets a predetermined condition, and the display means for displaying at least a part of the display object at the position on the first touch panel decided by the determining means.

The UI device may be configured such that, when a user presses the position of the display object displayed on the first touch panel with his finger or the like in an attempt for drag & drop between the first touch panel and the second touch panel placed in juxtaposition and slides the finger or the like on the first touch panel, the display object is displayed correspondingly at any position of the finger or the like.

Alternatively, the UI device may be configured such that, when a user moves his finger or the like from the first touch panel to the second touch panel, the display object transfers from the first touch panel to the second touch panel and is displayed on the second touch panel.

Also in the alternative, the UI device may be configured such that, after the display object is displayed on the second touch panel, the display object is displayed in response to the movement of the user's finger or the like on the second touch panel as with a conventional drag & drop on a single touch panel.

In summary, the UI device enables a user to perform a drag & drop operation over a plurality of touch panels, however it is not so limited and may enable other types of operations, such as a move operation or a cut and paste operation, for example.

The predetermined condition denotes when the pressed position enters a second boundary region 92 of the second touch panel 120, occupying a predetermined range from a side thereof closer to the first touch panel 110, thereby releasing the pressure, in the case where the first touch panel 110 and the second touch panel 120 are disposed in juxtaposition on substantially the same plane in the device.

The predetermined condition may denote a condition in which the pressed position enters a boundary region of the first touch panel 110 occupying a predetermined range from a side thereof closer to the second touch panel 120, thereby releasing the pressure, in the case where the first touch panel 110 and the second touch panel 120 are disposed in juxtaposition on substantially the same plane in the device.

Accordingly, when the user slides his finger or the like from the first touch panel 110 to the second touch panel 120, the object currently displayed on the first touch panel 110 can be displayed on the second touch panel 120.

The determining unit 144, for example, determines the destination position on the first touch panel 110 based on a position most recently pressed on the second touch panel 120 and a position pressed earlier by unit time.

The determining unit 144 may determine the destination position on the first touch panel 110 based on at least a position subject to a pressure detected from a time point earlier than the last release of the pressure until a time point of the current release of the pressure on the second touch panel.

Accordingly, the user can control the position of the display object shown on the first touch panel depending on, for example, a direction where the finger or the like placed on the display object moves on the second touch panel.

The determining unit 144, for example, determines the position on the first touch panel 110 based on a relative positional relationship between the first touch panel 110 and the second touch panel 120 in the case where the first touch panel 110 and the second touch panel 120 are disposed in juxtaposition on substantially the same plane in the device, and the position most recently pressed on the second touch panel 120 and the position pressed earlier by unit time.

The application for display control displays the display object, for example, icon, after a predetermined time since the pressure is released from the second touch panel 120 (corresponding to a time length when the display object stays in the range of the bezel 93).

The determining unit may determine the position on the first touch panel based on a relative positional relationship between the first touch panel and the second touch panel in the case where the first touch panel and the second touch panel are disposed in juxtaposition on substantially the same plane in the device, and at least a pressed position detected on the second touch panel from a time point earlier than the last release of the pressure until a time point of the current release of the pressure, and the display unit may display the display object after a predetermined time since the pressure is released from the second touch panel.

Accordingly, the display object can be suitably displayed on the first touch panel when the user slides his finger or the like currently placed on the second touch panel onto the first touch panel in the case where there is a space between the first and second touch panels.

The predetermined condition, for example, denotes such a condition that that the pressed position enters a second boundary region 92 of the second touch panel 120 occupying a predetermined range from a side thereof closer to the first touch panel 110, thereby releasing the pressure, and an absolute value of a value obtained by subtracting, from a y coordinate value of a position most recently pressed, a y coordinate value at a position pressed earlier by unit time (drag speed) is at least a predetermined value in the case where the first touch panel 110 and the second touch panel 120 are disposed in juxtaposition on substantially the same plane in the device.

The predetermined condition may denote such a condition that that the pressed position enters a boundary region of the second touch panel occupying a predetermined range from a side thereof closer to the first touch panel, thereby releasing the pressure, and a component of the pressed position in a direction substantially perpendicular to the side changes so as to direct toward the side per unit time to at least a predetermined extent from a time point earlier than the release of the pressure until a time point of the release of the pressure in the case where the first touch panel and the second touch panel are disposed in juxtaposition on substantially the same plane in the device.

Accordingly, the display object can be suitably displayed on the first touch panel depending on a speed at which the user moves his finger or the like on the second touch panel.

The determining unit 144, for example, determines the position on the first touch panel 110 so that the position changes a plurality of times at the intervals of unit time when the pressure is first applied on the first touch panel 110 since the pressure is released from the second touch panel 120 based on a relative positional relationship between the first touch panel 110 and the second touch panel 120 in the case where the first touch panel 110 and the second touch panel 120 are disposed in juxtaposition on substantially the same plane in the device, and the position most recently pressed and the position pressed earlier by unit time on the second touch panel 120.

The application for display control displays the display object at the determined position every time when the position is determined by the determining unit 144 after a predetermined time (corresponding to a time length when the display object stays in the range of the bezel 93) since the pressure is released from the second touch panel 120.

The determining unit of the UI device according to the present invention may determine the position on the first touch panel so that the position changes a plurality of times at the intervals of unit time when the pressure is first applied on the first touch panel since the pressure is released from the second touch panel based on a relative positional relationship between the first touch panel and the second touch panel in the case where the first touch panel and the second touch panel 120 are disposed in juxtaposition on substantially the same plane in the device, and at least a pressed position on the second touch panel detected from a time point earlier than the last release of the pressure until a time point of the current release of the pressure.

The display means may display the display object at the determined position every time when the position is determined by the determining unit after a predetermined time since the pressure is released from the second touch panel.

Accordingly, when the user slides his finger or the like from the second touch panel to the first touch panel, the display object leaves a track on the first touch panel even before the user touches the first touch panel, thereby making the user to more easily grasp a position on the first touch panel to be touched with his finger or the like.

A mobile telephone according to an embodiment of the present invention includes a UI device which includes a first touch panel 110 and a second touch panel 120, where a display object, such as an icon, is displayed correspondingly at a position currently subject to a pressure when the pressed position changes, thereby releasing the pressure, after the pressure is first applied to a position of the display object on the touch panels (in other words, during the drag state).

The mobile telephone, for example, includes a UI device provided with a determining unit 144 for determining a position on the first touch panel 110 in the case where variation of a position of a display object on the second touch panel 120 subject to a pressure detected by the time when the pressure is released from the position since the pressure is first applied to the position on the second touch panel 120 meets a predetermined condition, and an application for display control for displaying at least a part of the display object at the position on the first touch panel 110 determined by the determining unit 144.

The mobile terminal apparatus may include a UI device provided with a first touch panel 110 and a second touch panel 120, where a display object is displayed correspondingly at a position currently subject to a pressure by the time when the pressed position changes, thereby releasing the pressure, after the pressure is first applied to a position of the display object on the touch panels, the UI device further including a determining unit for determining a position on the first touch panel in the case where variation of the position of the display object on the second touch panel subject to the pressure detected by the time when the pressure is released from the position since the pressure is first applied to the position meets a predetermined condition, and a display unit for displaying at least a part of the display object at the position on the first touch panel determined by the determining unit.

The mobile terminal apparatus enables a user to perform drag & drop between a plurality of touch panels.

In an embodiment, the mobile telephone is a mobile terminal apparatus provided with a first touch panel 110 and a second touch panel 120, where a display object, such as an icon, is displayed correspondingly at a position currently subject to a pressure on the touch panels by the time when the pressure is released after the pressure is first applied, the mobile terminal apparatus also includes a processor for executing an application for display control for display-controlling the display object, and a controller for transmitting, on the first touch panel 110 or the second touch panel 120, a message indicative of start of the press to the application for display control when the press starts, a message indicative of a position to the application for display control when the pressed position changes, and a message indicative of release of the press to the application for display control when the press is released.

The controller, for example, transmits a message indicative of start of the press to the application for display control for display-controlling the display object when the press starts at a position of the display object displayed on the second touch panel 120, determines a position on the first touch panel 110 in the case where variation of the pressed position on the second touch panel 120 meets a predetermined condition, inhibits transmission of a message indicative of release of the pressure responding to release of the pressure on the second touch panel 120 when the press starts at the determined position on the first touch panel 110 after the pressure on the second touch panel 120 is released, transmits a message indicative of the determined position, and inhibits transmission of a message indicative of start of the press responding to start of the press on the first touch panel 110.

The mobile terminal apparatus may be provided with first and second touch panels, where a display object is displayed correspondingly at a pressed position by the time when the press is released after the press starts on the touch panels, the mobile terminal apparatus further including an executer for executing an application program for controlling the display of the display object, and a controller for transmitting, on the first touch panel or the second touch panel, a message indicative of start of the press to the application program when the press starts, a message indicative of a position to the application program when the pressed position changes, and a message indicative of release of the press to the application program when the press is released.

The controller may transmit a message indicative of start of the press to the application program for display-controlling the display object when the press starts at a position of the display object displayed on the second touch panel, determines a position on the first touch panel in the case where variation of a pressed position on the second touch panel meets a predetermined condition, inhibits transmission of a message indicative of release of the press responding to release of the press on the second touch panel when the press starts at the determined position on the first touch panel after the press on the second touch panel is released, transmits a message indicative of the determined position, and inhibits transmission of a message indicative of start of the press responding to start of the press on the first touch panel.

According an embodiment of the mobile terminal apparatus, where the transmission of particular messages is inhibited, it is more likely that the drag & drop between the first touch panel and the second touch panel can be implemented by relatively simple control steps in the application program for display-controlling the display object.

The mobile telephone is a mobile terminal apparatus provided with a first touch panel 110 and a second touch panel 120, where a display object is displayed correspondingly at a pressed position by the time when the press is released after the press starts on the touch panels, the mobile terminal apparatus further including a controller and an application for display control for displaying at least a part of the display object at a position on the first touch panel 110 in the case where variation of the pressed position detected by the time when the press is released after the press starts at a position of the display object on the second touch panel 120 meets a predetermined condition.

The mobile terminal apparatus may be provided with a first touch panel and a second touch panel, where a display object is displayed correspondingly at a pressed position by the time when the press is released after the press starts on the touch panels, the mobile terminal apparatus further including a display unit for displaying at least a part of the display object at a position on the first touch panel in the case where variation of the pressed position detected by the time when the press is released after the press starts at a position of the display object on the second touch panel meets a predetermined condition.

The mobile terminal apparatus enables a user to perform drag & drop between a plurality of touch panels, but is not so limited.

While at least one exemplary embodiment has been presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being included within the scope of the present disclosure as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1-13. (canceled)

14. A user interface apparatus comprising:
a first touch panel comprising a first boundary area thereon;
a second touch panel comprising a second boundary area thereon that is adjacent to the first boundary area, wherein a display object is operable to be dragged from one of the first and second touch panels to the other of the first and second touch panels through the first and second boundary areas; and
a controller, operably coupled to the first and the second touch panels, the controller operable:
to detect a location of a first press on the display object on the first touch panel;
to display a first portion of the display object in the first boundary area and display at a position in the second boundary area a second portion of the display object that is different from the first portion when the location is inside the first boundary area and when the second portion of the display object is not displayed on the first touch panel.

15. The user interface apparatus according to claim 14, wherein the controller is further operable to:
determine a destination point in the second boundary area based on a direction of movement of the first press when the location is inside the first boundary area, and
set the position to the destination point.

16. The user interface apparatus according to claim 14, wherein the controller is further operable:
to detect a release of the first press on the first touch panel;
to detect a second press on the second touch panel, following the release; and
to display the first and second portions of the display object at a location of the release and the second boundary area, respectively, until the second press is detected.

17. The user interface apparatus according to claim 14, wherein the controller is further operable to display the display object at a location of a second press on the second touch panel when the second touch is detected.

18. The user interface apparatus of claim 14, further comprising a bezel between the first touch panel and the second touch panel.

19. The user interface apparatus of claim 18, further comprising:
a first housing comprising the first touch panel therein; and
a second housing comprising the second touch panel therein.

20. The user interface apparatus of claim 19, wherein the first housing slides horizontally apart from the second housing to expose the second touch panel.

21. A user interface apparatus comprising:
first and second touch panels;
a controller operably coupled to the first and second touch panels, the controller operable:
to detect a press, movement of the press and release of the press on the first touch panel;
to determine a destination point on the second touch panel based on a direction of the movement;
to display a portion of a display object at a location of the destination point on the second touch panel when the portion of the display object is not displayed on the first touch panel during the movement.

22. The user interface apparatus of claim 21, further comprising a bezel between the first touch panel and the second touch panel.

23. The user interface apparatus of claim 22, further comprising:
a first housing comprising the first touch panel therein; and
a second housing comprising the second touch panel therein.

24. The user interface apparatus of claim 23, wherein the first housing slides horizontally apart from the second housing to expose the second touch panel.

25. A method of operating a user interface apparatus comprising two touch panels in which a display object is operable to be dragged from the first touch panel to the second touch panel, the method comprising:
displaying a display object on the first touch panel;
detecting a press on the display object, movement of the press and release of the press on the first touch panel;
displaying a portion of the display object at a position in the second touch panel when the portion of the display object is not displayed on the first touch panel during the movement.

26. The method according to claim 25, further comprising predicting a destination point on the second touch panel based on a direction of the movement, and then setting the position to the destination point.
